(19) United States
(12) Patent Application Publication
(10) Pub. No.: US 2012/0054289 A1
(43) Pub. Date: Mar. 1, 2012

(54) EMAIL COMMAND SYSTEMS AND METHODS

(76) Inventors: Doruk Aytulu, Santa Fe, NM (US); Joshua Thorp, Santa Fe, NM (US)

(21) Appl. No.: 13/198,667

(22) Filed: Aug. 4, 2011

Related U.S. Application Data
(60) Provisional application No. 61/376,985, filed on Aug. 25, 2010.

(51) Int. Cl. G06F 15/16

(52) U.S. Cl. 709/206

(57) ABSTRACT

Systems and methods are described that operate to manipulate networked applications and resources. A server is configured to extract a command from an Email message directed by a user to a predetermined address. A parser extracts parameters from the Email message, where the parameters configure and direct command execution. Parameters may be found in one or more fields of the Email message. The server responds to the command by manipulating an operational aspect of an application associated with the user and executed on a second, networked server. The command may be one of a set of commands maintained by the server. The server may maintain a customized set of commands for each registered user and default commands for unregistered users. Customized sets of commands may include commands created by the registered user.

### BACKGROUND OF THE INVENTION

1. Field of the Invention

The present invention relates generally to systems and methods for managing computer systems.

2. Description of Related Art

The growth in network applications, social networks and information management systems has resulted in ever increasing complexity for users. In conventional systems, users must master administrative functions for a wide variety of independently produced applications, which the user may use independently or in a coordinated manner. The administrative overhead of these various applications can result in abandonment of all but a few systems to manage high-priority tasks.

### BRIEF SUMMARY OF THE INVENTION

Certain embodiments of the invention provide systems and methods for manipulating networked applications. Certain embodiments comprise a server. In certain embodiments, the server is configured to extract a command from an Email message directed by a user to a predetermined address. Certain embodiments comprise a parser configured to parse fields of the Email message and to extract parameters for the command from the field. In certain embodiments, the server responds to the command by manipulating an operational aspect of an application associated with the user and executed on a second, networked server. In certain embodiments, the command is one of a set of commands maintained by the server. In certain embodiments, the server maintains sets of commands for registered and non-registered users. The sets of commands can be customized. In certain embodiments, the customized set of commands includes a user command generated by the user. In certain embodiments, the user command is operative to manipulate the application on the second server.

### BRIEF DESCRIPTION OF THE DRAWINGS

FIG. 1 is a schematic illustrating a system according to certain aspects of the invention.

FIG. 2 is a flowchart illustrating how a non-registered user is handled according to certain aspects of the invention.

FIG. 3 is a flowchart illustrating how a registered user is handled according to certain aspects of the invention.

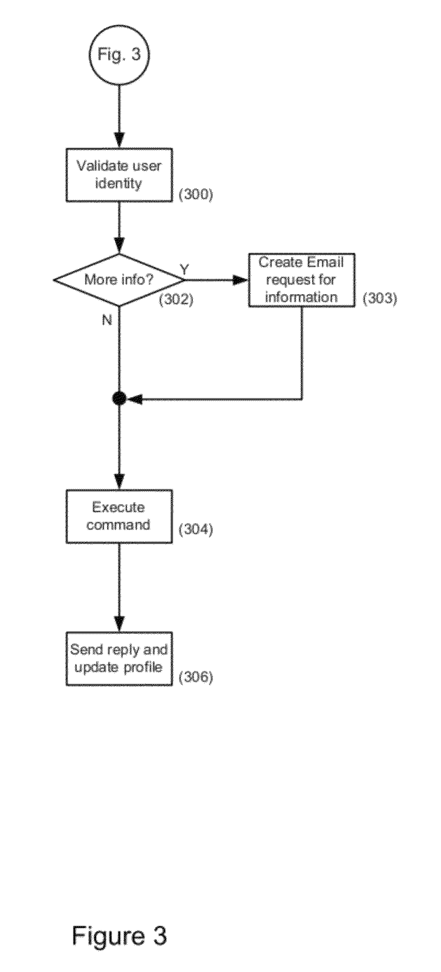

FIG. 4 is a simplified block schematic illustrating a processing system employed in certain embodiments of the invention.

FIG. 5 is a simplified block schematic illustrating a programming interface employed in certain embodiments of the invention.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration.

Certain embodiments of the invention systems and methods that provide command and control mechanisms that allow Email users to influence and control the state and operation of network resources. According to certain aspects of the invention, an Email command system (“ECS”) allows users to control and manage their digital lives through their email accounts. A user's digital life comprise web services and applications used by the user for various purposes, including business management, scheduling, managing finances, managing physical and virtual assets and resources, communication, access to digital media and entertainment. An email account can be a personal or may be assigned by an organization such as a corporation, an association or university.

Email systems are widely used and typically have a format that conforms to one or more conventions or standards. For example, Internet Email typically conforms to standards that are tracked and documented in requests for comments (“RFC”) published by the Internet engineering task force (“IETF”), including RFC 5322 which describes Internet email message format and RFC 2045-RFC 2049 that describes aspects of multi-media content attachments, also known as multipurpose Internet mail extensions (“MIME”). In general terms, an Email has at least a header and a body. The header comprises various fields that may include sender, receiver and reply-to Email addresses, date, message identifier, content type and precedence. Other combinations of fields may be supported by the Email system. Certain aspects of the invention described herein can be applied to public and private Email systems, whether supported in a traditional data communications network, WiFi, cellular or other networks. Email addresses commonly have two parts separated by an @ sign. The part before the @ sign is known as the local-part of the address, which conventionally signifies a user name. The second part after the @ sign is conventionally a domain name to which the email message will be sent.

Emails can be generated, transmitted, received and managed through systems that are web based, such as Gmail, Yahoo Mail and/or Hotmail. Desktop Email clients such as Outlook or Thunderbird can also be used. Any user having a valid email account can use ECS through any email capable device, whether the user has been registered, or is unregistered with the system. Typically, the user accesses their Email system and, consequently, can access the ECS using a wide variety of computing devices including desktop computers, notebook computers, tablets, smart phones, laptops, readers, multimedia players, etc. In one typical example, a portable wireless device such as a smart phone is used to access the user's Email system. Such device can be controlled through touch screen, physical keyboard, gestures or voice. ECS can operate of the underlying Email client, host computing device, and operating system.

After ECS registration, a user can access additional features and advanced user settings. Registered Users can customize their profiles, accounts; add web services that they use by providing the required credentials to ECS and/or by signing in to ECS with other web service login credentials. The advanced features include customizing the user experience.

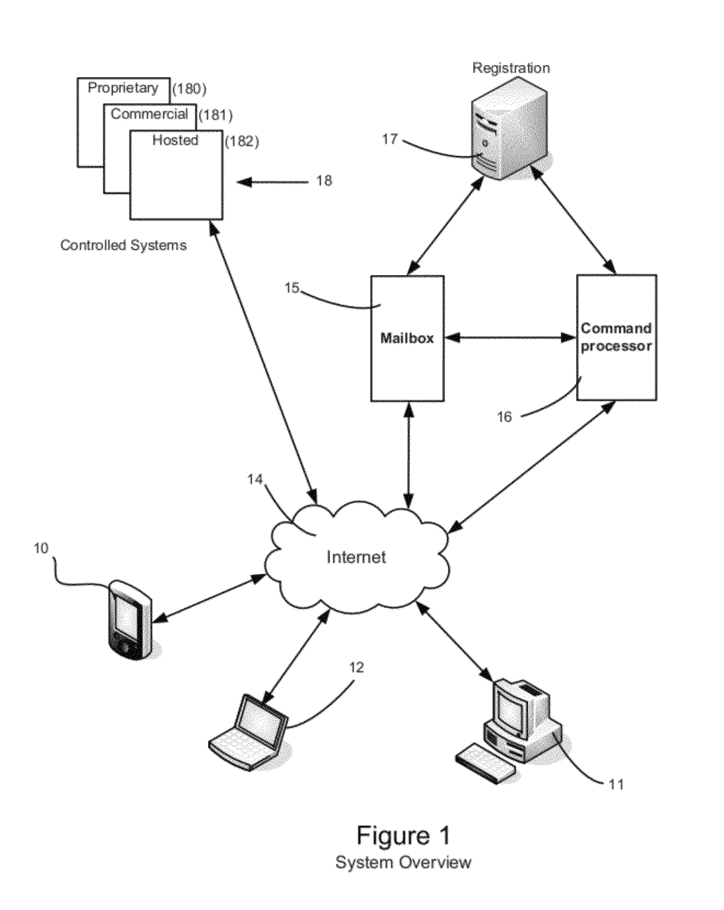

FIG. 1 illustrates a simplified representation of systems used in certain embodiments of the invention. A server 15 or other computing system is configured to receive Email directed to the system Email address. Email messages can be received from any suitable client device including, for example, a smart phone 10, a desktop computing system 11 and a mobile processing device such as a notebook computer 12. Other devices capable of transmitting and receiving Email can be used, including media players, gaming devices, cell phones, navigation systems, in-vehicle systems, voice response systems, voicemail systems, home automation equipment, manufacturing equipment, sensors, home appliances and so on. Email is typically transmitted, at least for a portion of its path, over the Internet 14 or some other transport network. Command processor 16 can parse Email messages for command words and command structures. If such commands are discovered and optionally verified, then a command may be invoked to perform one or more functions involving an application hosted by the mailbox 15, command processor 16, a related registration manager 17 or external application servers or systems 16. External systems can comprise commercial systems 181 that provide financial, social networking, information management, home automation or other services. Proprietary systems 180 associated with a user may also be controlled or managed. In certain embodiments, user may create one or more applications 182 to be hosted by the system or hosted externally.

### Non-Registered Users

In certain embodiments, anyone with a valid email account can utilize basic ECS functionality by sending an email to a predefined email address. User types at least one predefined command and/or keyword in the subject line of the email and sends the email to one of the predefined ECS email addresses. The ECS may then parse the email, search for command and/or keyword matches, execute the command and send a confirmation email when the action intended by the user is identified and executed. The confirmation email may also include the requested content by the user or a file which could be embedded or attached to an email. The confirmation Email may include suggested next steps and other procedural information.

In some embodiments, the command may be embedded elsewhere in the Email, including for example In the body, in an attachment or in another field such as the Email address itself. In certain embodiments, the various fields of an Email may be searches for commands, command arguments and other information.

In one example, an image can be attached to an Email message. If the ECS cannot identify a keyword or command in the subject line then ECS generates and sends an email, which can comprise one or more attributes. The attributes may comprise a confirmation request for at least one suggested action by the ECS when ECS cannot identify the intended command/action. The suggested action can be selected based on historical ECS network usage, and available commands and actions related to web applications associated that the user and for which ECS can be used to manipulate, control or otherwise access. The attributes may comprise an error message informing the user the ECS needs more information when ECS cannot identify the intended command and/or action or if some serious error is discovered in the command or action. The attributes may comprise an embedded link, which the user can click and confirm the execution of suggested actions by the ECS, when ECS cannot identify the intended command and/or action.

The attributes may comprise an embedded link, which the user can click and claim their temporary account on ECS. The attributes may comprise guidelines and instructions to construct Email messages, which ECS can use to parse and execute the commands accurately. The attributes may comprise content requested by the user, when ECS is commanded to extract and aggregate information from pre-selected web applications and other services, which use the Internet backbone to transfer data. ECS can pre-select applications for certain applications, for instance if the command has any local aspect, ECS can aggregate data from default applications and services focusing on local data. The service or application could be a web service running on world wide web, or could be an application using the Internet backbone running on proprietary platforms such as Apple App Store, Blackberry Appworld, Android Market or other such sources of applications.

A non-registered user can provide multiple commands, and multiple parameters may be defined in the subject line or body of the email. If a command is associated with certain data type or file, including image, audio, video file types or text, the data/file can be attached or embedded in the body of the email for ECS to parse the data, in all formats, and execute the associated command. If the user commands a valid action associated with text or rich media data, ECS can generate an email and reply to the user with requested attachments, text or rich media in the body of the email. For instance user can perform a search within a certain web application, web service or a database and ECS can attach the requested file in the reply email. The file can be a rich media file, such as an image, video, or a document such as PDF or Word, Power Point etc.

Certain embodiments provide a default action or series of actions that are taken if a command is not detected in the subject line. One effect of the default action is that transmitting an Email to a predefined Email address itself is construed as an implied command that is overridden if an explicit command is found in the subject line or elsewhere in the Email. The default action may be configured to cause the Email body to be parsed for an explicit or hidden command and/or to cause any attachments to be examined for embedded commands. The default action may examine attachments and based on the nature or content of the attachment, may select one or more preconfigured default actions that typically include an action related to the attachment or attachment type.

In certain embodiments, a default action may be configured to cause the Email body to be parsed for a modifier or for an explicit or hidden command. The content of the sender field, copy field, and settings of priority flags, etc., may select or modify a default action. In some embodiments a combination of an Email directed to an Email address and a setting of a field may trigger a specific action.

Default actions may be configured to enable a covert or disguised command language where the commands are not openly expressed, but are encoded using attachment type, or the inclusion of one or more keywords, or a combination of keywords in the Email or its attachments. Likewise, common abbreviations in the body or subject line may trigger a default action. In one example, the appearance of “RE:” or “FW:” or a combination such as “RE: FW:,” then a specific default action may be performed. A predefined address in an address field may carry additional information such as a location, category, folder or table in an e-filing system in which an attachment is to be copied.

In one example of a covert command may cause an attachment to be printed, faxed, filed or forwarded according to some predefined protocol or procedure. The covert command is triggered by the content of a non-displayable field, such as the presence of a predefined address in the blind carbon copy (bcc:). The receipt of the Email at the predefined address may trigger the covert command to perform a predetermined filing or other function.

In certain embodiments, default actions can be customized for each user. The default action to be performed upon receipt of an Email may be selected based on the content of the sender field of the Email. In this manner, each user can have a set of customized commands that are performed in response to determination of a default action.

FIG. 1 illustrates a process according to certain aspects of the invention. With reference to FIG. 1, the process commences at step 200 upon receipt of an Email from a user, who can be anyone with a valid email address who sends an email to a predefined email address, typically of the format xyz@abcd.com). The Email may be sent from any email capable device such as a tablet, a smart phone, a desktop, a laptop or any other email capable device. At step 202, the ECS checks the validity of the email. At step 210, the system can identify and reject invalid Email messages, unwanted Email messages (spam) and/or malicious Email messages (virus, worms, malware) and can log the sender information. At step 204 the ECS parses all fields in the Email message and evaluates all information within the email, including user/sender information (name, email address), subject line, body, attachments and other fields (carbon copy). A command may be provided in the address field in accordance with a predefined structure; for example, a command could take the form RESIZE300X500@abcd.com.

At step 206 ECS, determines if the user is registered or previously known. The ECS seeks user information, whether a registered or unregistered user to determine if a user should be registered, etc. Registered users are processed at step 207. At step 208 ECS cross references parsed information to system settings and previous network and individual usage behavior. ECS typically inspects the Subject Line for specific or implied user commands. Commands which exactly match with the predefined system commands are identified. Furthermore the ECS may check for keywords highly utilized by the ECS user network. ECS can also seek for correlations between the specific commands (user actions), user actions implied through keywords, the body of the email, carbon copied recipients and the attachments. At step 210, ECS evaluates whether the user action is well defined with predefined commands and can be executed accurately. If more information is needed then the system generates an email (see 114).

At step 212, ECS executes user's command if no additional information is needed, and may generate and send an Email reply. The reply Email can comprise one or more elements, the elements including a confirmation notice for the executed command, the retrieved information the user has demanded, which may be embedded in the email body or attached as a file, a suggested action based on the executed command. By looking at the ECS individual user and network usage history, ECS can automatically generate follow-on action suggestions and can inform the user of appropriate next actions. Also, if the user is a first time user the ECS may be configured to generate a temporary account which can be claimed by clicking on a confirmation link embedded in the reply email.

At step 211, the ECS may require more information to determine user's intent. An email can be generated to request more information from the user. The Email may contain a suggested action, such as “did you mean xyz? If yes please do xyz (click here, or reply to this email with a command to confirm the action).” If no suggestion can be generated, then an error message is sent to the user. The error message contains instructions and predefined commands in order to educate them how ECS would be used.

Certain embodiments comprise a component that monitors and analyzes system activity. This component may perform analytics on the user activity and may be used to optimize and generates or modifies actions and recommendations.

### Registered Users

ECS can create temporary accounts for non-registered users. Users can typically claim their accounts by clicking on a link embedded in the reply Emails that ECS generates. Users can also register to the ECS via an external webpage or by signing in with their approved third party accounts, such as Twitter, Facebook, Google etc. In certain embodiments, a specific set of predefined commands can be provided for registered users to manage and control web applications and services compatible with ECS. In addition, registered users can customize ECS and assign commands for specific tasks. These commands can typically be assigned directly for ECS or for the web services that users add to their ECS account. Self-assigned commands can replace or perform the same task with the specific commands assigned by the ECS. For instance, the predefined ECS command “PUBLISH” for posting to a WordPress account, could be replaced or work in parallel with user's self assigned command “P”. It is anticipated that command names can be customized by the user or the system provider. For example, a generic “PUBLISH” command could be renamed “Wordpress” to assist users identify the publishing process followed. Users can also add multiple emails to their account so that user's added web applications could be control and managed from multiple email addresses.

ECS can be packaged as a building block or as an extension of an existing Email application within an organization, where users are already registered with organization's contact database (employers of a corporation, students of an educational institutions, members of an association or a group etc). Since the identities of the internal email users are known, they are automatically registered with the ECS and can perform predetermined advanced tasks.

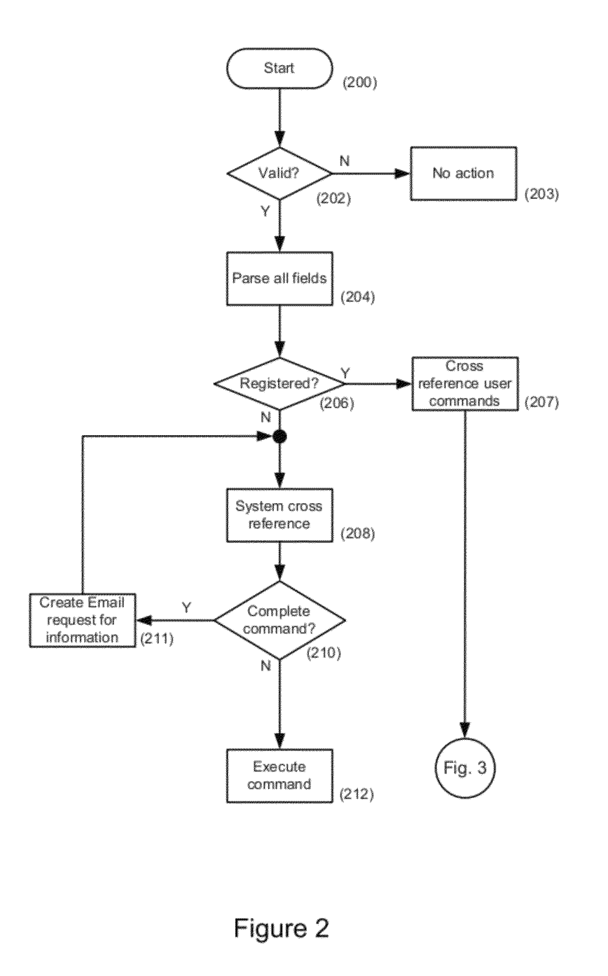

With reference to FIG. 2, at step 300 registered user typically has a predefined ECS profile (which may be a default profile) and may have access to more features and advanced settings. A user may be able to add other web services (such as Facebook, Twitter, Flickr etc.) to their profiles. In addition to their ECS profile and account, a registered user can manage and control these web services by sending an Email to ECS. User can issue predetermined commands for these services or can assign new commands to perform specific tasks. For instance, for a blogging product, if the predefined command is “Publish” the user can assign other web services to this command and ECS can publish whatever user wants to publish on these platforms, with just one email. The body of the email can be a blog post which could be posted on multiple platforms associated with the “publish” command. User can use a customized command instead of the predefined command “Publish”, for instance user's preferred command could be the letter “P” or the word “PUB” which would perform the same task as “PUBLISH”.

At step 302, ECS inspects the email to determine whether more information is needed to execute a received command and decides if the command can be executed. At step 303, ECS can generate an Email message to request more information, as needed, the Email message explaining why no execution occurred and optionally requesting more information. In addition, ECS can generate a confirmation link to perform the most likely task that the user intended to take. Suggestions may be generated based on the ECS network usage and individual usage history of the user. At step 304, ECS executes commands, generates an Email message comprising one or more elements, the elements including a confirmation for the executed command, content aggregated or generated as a result of the command or commands. Examples of elements include results for a SEARCH command, a link to user's profile where the user can view the history of the actions user took through ECS.

### ECS Application Programming Interface (API)

In addition to the registered users who can customize their account and settings, ECS can be used and customized within an organization. ECS can be located on-sire or off-site and may be customized for an organization. Typically an application programming interface (“API”) is published to permit customization and enhancement of the ECS. Examples of customization performed by organizations include:
Organizations can assign email addresses for specific tasks such as search@organization xyz.com or help@organization xyz.com.
Organizations can assign their own commands and keywords
Organizations can assign theft own actions based on the commands
   The ECS API typically enables organizations to assign email addresses and manage the messages addressed to those email addresses.

In certain embodiments, an ECS may be privately managed and executed on an enterprise server in a manner customized to the enterprise activity. For example, the sales force of an enterprise may interact with manufacturing and shipping by transmitting Email messages that are intercepted by the ECS and interpreted to identify commands that enable manufacturing to produce a specific version of product for an identified customer and/or that permits shipping to schedule delivery based on information in the Emails (e.g. a scanned business card or other contact information attached to the Email).

In certain embodiments, the ECS, or a component of the ECS, may be deployed in a computing appliance or specific computing device to control or monitor processes associated with the appliance or device. For example, the ECS may be deployed in a home automation system and may be configured to receive Email that enables, disables and/or configures components of the automation system such as air conditioning, alarm, entertainment systems, lighting and access control. For example, a home owner may send an Email with an embedded command in the subject field stating “Temp 72” that causes the cooling/heating system to adjust temperature of one or more sectors of the home to the desired 72° F.

In certain embodiments, the ECS may be implemented on a logical or virtual computer, including systems used in the provision of on-demand software (software as a service), and cloud computing. The ECS can be provided as a core service offering that may be configured and customized for organizations using the service or the ECS can be implemented on an enterprise server that interacts with a virtual computing environment supported by a service provider. In either format, the ECS can be configured to interact with virtual resources and, at least some embodiments, can be used to manage the systems implementing the virtual resources.

As described above, a user may initiate a registration process using any Email address that was not previously registered by the ECS. An unregistered user may be temporarily or provisionally registered pending acceptance of registration (typically by Email). In some embodiments, registered users can create applications to be performed by the ECS. The applications may be shared with other individuals or groups and/or may be made publicly available for access by any user. In one example, a user may create an application that is relevant to preparing and filing tax returns and which includes decision processes based on current year tax laws and rules.

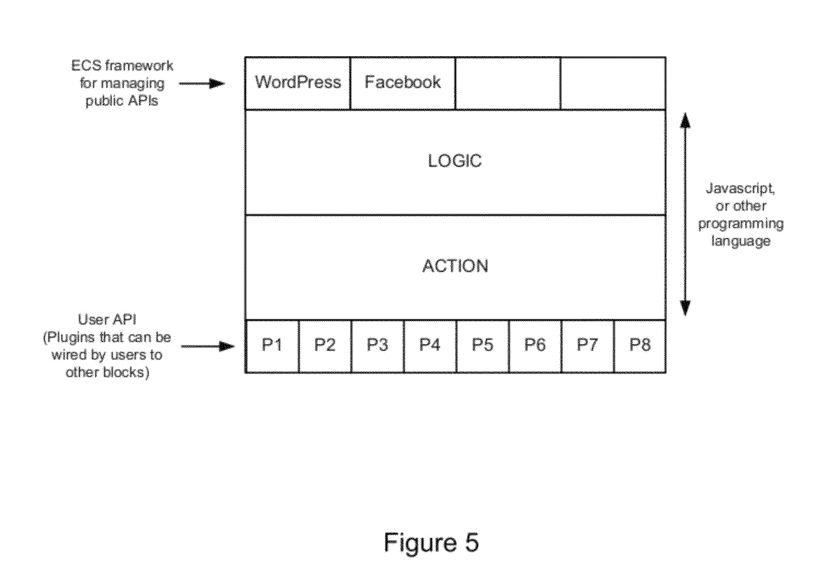

With reference to FIG. 5, a user can create an application, and then create an Email that includes one or more commands known to the ECS that cause the ECS to acknowledge and register a new command and/or application. For example, the user may create a sequence of actions required to access an account balance in a financial application, online banking portal and/or another web-based application. The new command may be a macro command that specifies a sequence of commands to be performed and an order and format for data entry. The new command may also invoke a new application created by the user using an accepted programming language and an API published by the ECS operator. The API identifies the format of functions, commands and standard applications that may be called from user's new application The user application must typically be dynamically (or statically) linked to the ECS system before it can be loaded and executed. The user may also be required to provide a programmatic description of the new command to permit publication in a library and may also require a description of the command to allow users to execute the command using an Email message.

In certain embodiments, ECS provides a platform and a marketplace for applications, which can include built-in or provider-created applications and applications created by users and/or commercial providers. Providers may brand and offer applications for sale. Users can search for applications, and are provided an ability to create scripts. A user may assign an email address associated with a script and assign commands and upload the script. One email address can be used with multiple applications since after assigning the email address user can assign multiple commands for senders' to put in the subject line. For example, xyz@xyz.com email address could perform one function with “SEARCH” command and another function with “PUBLISH”. The ECS infrastructure enables users to create applications based on their own needs (such as an expense management system which ties to their accounting system) or for public use. The API may include calls for public applications such as Facebook, Twitter, Yelp, Wikipedia, Wordpress etc. Email, command and script wiring can be performed using a GUI, although it is anticipated that some users may prefer to use a custom or commercial programming environment. In a GUI interface example, users may drag and drop multiple scripts to create complex applications. A first user, User A, may create an application to which a second user, User B, wants to merge one or more additional applications; User A can do so by simply dragging “blocks” in the GUI.

It will be appreciated that commands may be structured to permit predefined modification, addition or reconfiguration of parameters to allow the command to be applied to different third party systems. For example, a logon process for any web based application may require a common set of information (username and password) that can vary for different applications used by the same user. According to certain aspects of the invention, the user profile may identify which username and/or password should be used for each application.

Certain embodiments employ keyed access to applications. Commercial providers of applications may distribute applications under license agreements with users who have purchased the provider's applications. License management can be enforced through a number of approaches, including known methods of enforcement using keys to unlock features of the application. However, in certain embodiments, the ECS manages licensing through user profiles. For example, a commercial provider may maintain a listing of authorized ECS users who can be provided access to the provider's application. The Provider may also update a profile management database maintained by the ECS profile manager. Accordingly, a user Email message, which includes a command that invokes the provider application, may cause the profile manager to identify the desired application, determine whether the user is authorized to access the application and provide access accordingly. In some embodiments, features of the application may be individually identified and user rights assigned by feature. For many applications, unlimited access is provided and default access rights may be assigned.

### System Description

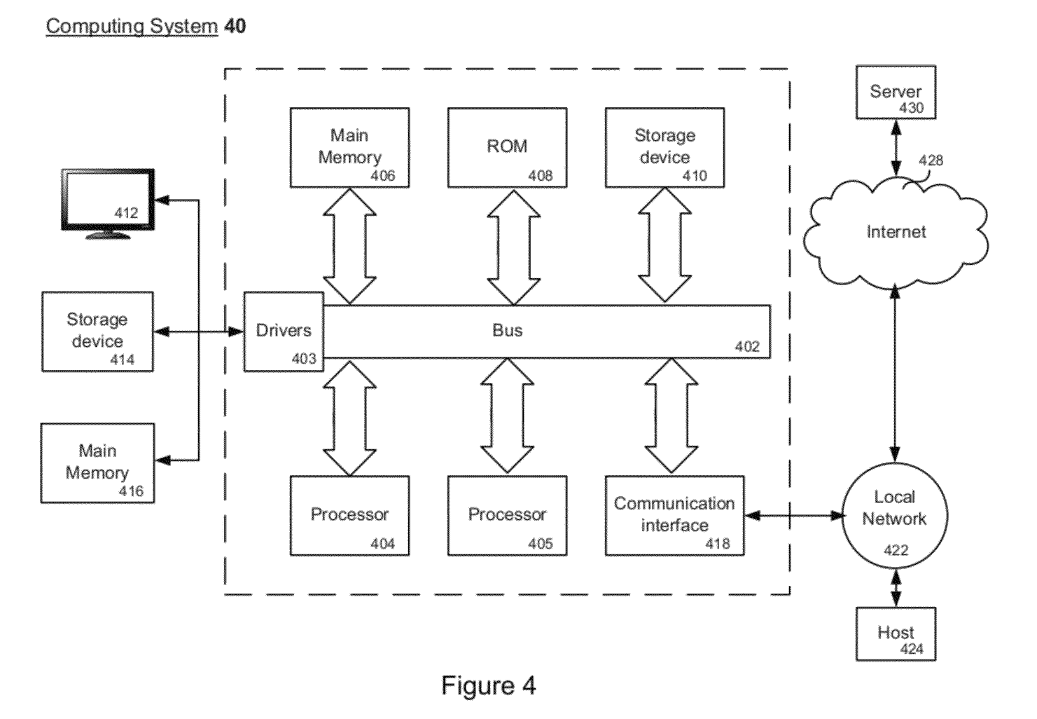

Turning now to FIG. 4, certain embodiments of the invention employ a processing system that includes at least one computing system 400 deployed to perform certain of the steps described above. Computing systems may be a commercially available system that executes commercially available operating systems such as Microsoft Windows®, UNIX or a variant thereof, Linux, a real time operating system and or a proprietary operating system. The architecture of the computing system may be adapted, configured and/or designed for integration in the processing system, for embedding in one or more of an image capture system, a manufacturing/machining system, a graphics processing workstation and/or a . . . . In one example, computing system 400 comprises a bus 402 and/or other mechanisms for communicating between processors, whether those processors are integral to the computing system 40 (e.g. 404, 405) or located in different, perhaps physically separated computing systems 400. Device drivers 403 may provide output signals used to control internal and external components

Computing system 400 also typically comprises memory 406 that may include one or more of non transitory storage, random access memory (“RAM”), static memory, cache, flash memory and any other suitable type of storage device that can be coupled to bus 402. Memory 406 can be used for storing instructions and data that can cause one or more of processors 404 and 405 to perform a desired process. Main memory 406 may be used for storing transient and/or temporary data such as variables and intermediate information generated and/or used during execution of the instructions by processor 404 or 405. Computing system 400 also typically comprises non-volatile storage such as read only memory (“ROM”) 408, flash memory, memory cards or the like; non-volatile storage may be connected to the bus 402, but may equally be connected using a high-speed universal serial bus (USB), Firewire or other such bus that is coupled to bus 402. Non-volatile storage can be used for storing configuration, and other information, including instructions executed by processors 404 and/or 405. Non-volatile storage may also include mass storage device 410, such as a magnetic disk, optical disk, flash disk that may be directly or indirectly coupled to bus 402 and used for storing instructions to be executed by processors 404 and/or 405, as well as other information.

Computing system 400 may provide an output for a display system 412, such as an LCD flat panel display, including touch panel displays, electroluminescent display, plasma display, cathode ray tube or other display device that can be configured and adapted to receive and display information to a user of computing system 400. Typically, device drivers 403 can include a display driver, graphics adapter and/or other modules that maintain a digital representation of a display and convert the digital representation to a signal for driving a display system 412. Display system 412 may also include logic and software to generate a display from a signal provided by system 400. In that regard, display 412 may be provided as a remote terminal or in a session on a different computing system 400. An input device 414 is generally provided locally or through a remote system and typically provides for alphanumeric input as well as cursor control 416 input, such as a mouse, a trackball, etc. It will be appreciated that input and output can be provided to a wireless device such as a PDA, a tablet computer or other system suitable equipped to display the images and provide user input.

According to one embodiment of the invention, portions of the ECS parser described above may be performed by computing system 400. Processor 404 executes one or more sequences of instructions. For example, such instructions may be stored in main memory 406, having been received from a computer-readable medium such as storage device 410. Execution of the sequences of instructions contained in main memory 406 causes processor 404 to perform process steps according to certain aspects of the invention. In certain embodiments, functionality may be provided by embedded computing systems that perform specific functions wherein the embedded systems employ a customized combination of hardware and software to perform a set of predefined tasks. Thus, embodiments of the invention are not limited to any specific combination of hardware circuitry and software.

The term “computer-readable medium” is used to define any medium that can store and provide instructions and other data to processor 404 and/or 405, particularly where the instructions are to be executed by processor 404 and/or 405 and/or other peripheral of the processing system. Such medium can include non-volatile storage, volatile storage and transmission media. Non-volatile storage may be embodied on media such as optical or magnetic disks, including DVD, CD-ROM and BluRay. Storage may be provided locally and in physical proximity to processors 404 and 405 or remotely, typically by use of network connection. Non-volatile storage may be removable from computing system 404, as in the example of BluRay, DVD or CD storage or memory cards or sticks that can be easily connected or disconnected from a computer using a standard interface, including USB, etc. Thus, computer-readable media can include floppy disks, flexible disks, hard disks, magnetic tape, any other magnetic medium, CD-ROMs, DVDs, BluRay, any other optical medium, punch cards, paper tape, any other physical medium with patterns of holes, RAM, PROM, EPROM, FLASH/EEPROM, any other memory chip or cartridge, or any other medium from which a computer can read.

Transmission media can be used to connect elements of the processing system and/or components of computing system 400. Such media can include twisted pair wiring, coaxial cables, copper wire and fiber optics. Transmission media can also include wireless media such as radio, acoustic and light waves. In particular radio frequency (RF), fiber optic and infrared (IR) data communications may be used.

Various forms of computer readable media may participate in providing instructions and data for execution by processor 404 and/or 405. For example, the instructions may initially be retrieved from a magnetic disk of a remote computer and transmitted over a network or modem to computing system 400. The instructions may optionally be stored in a different storage or a different part of storage prior to or during execution.

Computing system 400 may include a communication interface 418 that provides two-way data communication over a network 420 that can include a local network 422, a wide area network or some combination of the two. For example, an integrated services digital network (ISDN) may used in combination with a local area network (LAN). In another example, a LAN may include a wireless link. Network link 420 typically provides data communication through one or more networks to other data devices. For example, network link 420 may provide a connection through local network 422 to a host computer 424 or to a wide are network such as the Internet 428, Local network 422 and Internet 428 may both use electrical, electromagnetic or optical signals that carry digital data streams.

Computing system 400 can use one or more networks to send messages and data, including program code and other information. In the Internet example, a server 430 might transmit a requested code for an application program through Internet 428 and may receive in response a downloaded application that provides for the anatomical delineation described in the examples above. The received code may be executed by processor 404 and/or 405.

### Additional Descriptions of Certain Aspects of the Invention

The foregoing descriptions of the invention are intended to be illustrative and not limiting. For example, those skilled in the art will appreciate that the invention can be practiced with various combinations of the functionalities and capabilities described above, and can include fewer or additional components than described above. Certain additional aspects and features of the invention are further set forth below, and can be obtained using the functionalities and components described in more detail above, as will be appreciated by those skilled in the art after being taught by the present disclosure.

Certain embodiments of the invention provide systems and methods for controlling a plurality of network resources. Certain embodiments comprise receiving a message directed to a predetermined address, and transmitted through an E-mail system by a client device. Certain embodiments comprise determining if command information is present in one or more fields of the message. Certain embodiments comprise selecting a command consistent with the command information when command information is present in one or the fields of the message. In certain embodiments, the command is directed to a network resource. Certain embodiments comprise manipulating an operational aspect of the network resource responsive to the command. In certain embodiments, the operational aspect is associated with a user of the client device. In certain embodiments, the command is one of a set of commands associated with the user.

Certain embodiments comprise selecting a default command as the command when command information is not present in the one or the fields of the message. In certain embodiments, the user is a registered user and the set of commands includes commands customized for the user. In certain embodiments, the user is a non-registered user. Certain embodiments comprise creating a registration message for transmission to the user upon receipt of the message. Certain embodiments comprise creating the set of commands for the user from a template set.

In certain embodiments, parsing the command information includes extracting one or more parameters associated with the command. In certain embodiments, the network resource maintains the set of commands and the operational aspect affects the set of commands. Certain embodiments comprise maintaining a profile for the user, the profile identifying information used to access the network resource. In certain embodiments, the default command is selected based on a type of attachment to the Email. In certain embodiments, the command information is present in a non-displayed field of the message and wherein the command is selected from a set of covert commands.

Certain embodiments comprise one or more network application controlled by a network user. Certain embodiments comprise a server configured to execute a command based on the presence of a predetermined address in an Email message sent by the user. Certain embodiments comprise a parser configured to parse fields of the Email message for parameters for the command. In certain embodiments, the server responds to the command by manipulating an operational aspect of the one or more network application. In certain embodiments, the command is one of a set of commands maintained by the server and corresponding to the network user. In certain embodiments, the server maintains a customized set of commands for each of a plurality of registered users. In certain embodiments, the customized set of commands includes a user command generated by the each registered user. In certain embodiments, the user command is operative to manipulate a network application on a different server.

Certain embodiments of the invention provide systems and methods for manipulating networked applications. Certain embodiments comprise a server. In certain embodiments, the server is configured to extract a command from an Email message directed by a user to a predetermined address. Certain embodiments comprise a parser configured to parse fields of the Email message and to extract parameters for the command from the field. In certain embodiments, the server responds to the command by manipulating an operational aspect of an application associated with the user and executed on a second, networked server. In certain embodiments, the command is one of a set of commands maintained by the server. In certain embodiments, the server maintains a customized set of commands for a registered user. In certain embodiments, the customized set of commands includes a user command generated by the registered user. In certain embodiments, the user command is operative to manipulate the application on the second server.

Certain embodiments of the invention provide systems and methods for controlling a plurality of network resources. Certain embodiments comprise receiving a message directed to a predetermined address. In certain embodiments, the message is transmitted through an E-mail system. In certain embodiments, the message is generated by a user of a client device. Certain embodiments comprise extracting command information from one or more fields of the message. Certain embodiments comprise parsing the command information to obtain a command directed to a network resource. Certain embodiments comprise manipulating an operational aspect of the network resource responsive to the command. In certain embodiments, the operational aspect associated with a user of the client device. In certain embodiments, the command is one of a set of commands associated with the user.

In certain embodiments, the user is a registered user and the set of commands includes commands customized for the user. In certain embodiments, the user is a non-registered user. Certain embodiments comprise creating a registration message for transmission to the user upon receipt of the message. Certain embodiments comprise creating the set of commands for the user from a template set. In certain embodiments, parsing the command information includes extracting one or more parameters associated with the command. In certain embodiments, the network resource maintains the set of commands and the operational aspect affects the set of commands. Certain embodiments comprise maintaining a profile for the user, the profile identifying information used to access the network resource,

Certain embodiments of the invention provide systems and method for controlling network resources. Certain embodiments comprise receiving at a server, a message directed by a user to a predetermined E-mail address. Certain embodiments comprise determining if one or more fields of the message includes command information. Certain embodiments comprise manipulating an operational aspect of a network resource accessible to the user in accordance with the command information when command information is determined to be present in the one or more fields of the message. Certain embodiments comprise maintaining a set of commands on the server for each of a plurality of users of a networked system. In certain embodiments, the set of commands includes one or more commands customized for the user.

In certain embodiments, wherein the user is a registered user and set of commands includes at least one command customized by the user. Certain embodiments comprise manipulating an operational aspect of a network resource in accordance with a default command when command information is determined to be absent from the one or more fields of the message. In certain embodiments, the default command is selected based on the content of an address filed of the message. In certain embodiments, the default command is selected based on a type of an attachment to the Email. In certain embodiments, the user is a non-registered user. Certain embodiments comprise creating a registration message for transmission to the user upon receipt of the message. Certain embodiments comprise creating and subsequently maintaining a set of commands for the user. Certain embodiments comprise parsing a body of the message to determine if the body includes command information. Certain embodiments comprise manipulating one or more operational aspects of the network resource in accordance with the command information when command information is determined to be present in the body.

In certain embodiments, wherein parsing the command information includes extracting one or more parameters associated with the command. Certain embodiments comprise maintaining a profile for the user, the profile identifying information used to access the network resource. In certain embodiments, command information present in the body includes a disguised command.

Certain embodiments comprise one or more networked resources having at least one aspect of its operation controllable by a network user. Certain embodiments comprise a server configured to extract a command from an Email message directed to an Email address by the network user and further configured manipulate an operational aspect of the one or more networked resources based on the command extracted from the Email message. In certain embodiments, the command is one of a set of commands maintained by the server and corresponding to the network user. In certain embodiments, the server maintains a customized set of commands for each of a plurality of registered users. In certain embodiments, the customized set of commands includes a user command generated by the each registered user.

In certain embodiments, the server is embodied in an appliance. In certain embodiments, the server is a logical server and the one or more networked resources includes a resource provided by a cloud computing system. In certain embodiments, the Email address is associated with an Email domain that includes the server. In certain embodiments, the local-part of the Email address includes the command.

In certain embodiments, the methods are embodied in a non-transitory computer-readable medium encoded with data and instructions wherein the data and instructions, when executed by a processor of a networked server, cause the server to perform one or more of the methods.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense.

What is claimed is:

1. A method for controlling network resources, comprising:
receiving at a server, a message directed by a user to a predetermined Email address; and
determining if one or more fields of the message includes command information;
when command information is determined to be present in the one or more fields of the message, manipulating an operational aspect of a network resource accessible to the user in accordance with the command information.

2. The method of claim 1, further comprising: maintaining a set of commands on the server for each of a plurality of users of a networked system, wherein the set of commands includes one or more commands customized for the user.

3. The method of claim 2, wherein the user is a registered user and set of commands includes at least one command customized by the user,

4. The method of claim 1, further comprising manipulating an operational aspect of a network resource in accordance with a default command when command information is determined to be absent from the one or more fields of the message.

5. The method of claim 4, wherein the default command is selected based on the content of an address filed of the message.

6. The method of claim 4, wherein the default command is selected based on a type of an attachment to the Email.

7. The method of claim 2, wherein the user is a non-registered user and further comprising:
upon receipt of the message, creating a registration message for transmission to the user; and
creating and subsequently maintaining a set of commands for the user.

8. The method of claim 1, further comprising parsing a body of the message to determine if the body includes command information; and
when command information is determined to be present in the body, manipulating one or more operational aspects of the network resource in accordance with the command information.

9. The method of claim 8, wherein parsing the command information includes extracting one or more parameters associated with the command.

10. The method of claim 9, further comprising maintaining a profile for the user, the profile identifying information used to access the network resource.

11. The method of claim 8, wherein command information present in the body includes a disguised command.

12. A system comprising:
one or more networked resources having at least one aspect of its operation controllable by a network user; and
a server configured to extract a command from an Email message directed to an Email address by the network user and further configured manipulate an operational aspect of the one or more networked resources based on the command extracted from the Email message,
wherein the command is one of a set of commands maintained by the server and corresponding to the network user, and
wherein the server maintains a customized set of commands for each of a plurality of registered users, the customized set of commands including a user command generated by the each registered user.

13. The system of claim 12, wherein the server is embodied in an appliance.

14. The system of claim 12, wherein the server is a logical server and the one or more networked resources includes a resource provided by a cloud computing system,

15. The system of claim 12, wherein the Email address is associated with an Email domain that includes the server.

16. The system of claim 15, wherein the local-part of the Email address includes the command,

17. A non-transitory computer-readable medium encoded with data and instructions wherein the data and instructions, when executed by a processor of a networked server, cause the server to perform a method comprising:
receiving at a server, a message directed by a user to a predetermined E-mail address; and
determining if one or more fields of the message includes command information;
when command information is determined to be present in the one or more fields of the message, manipulating an operational aspect of a network resource accessible to the user in accordance with the command information.

18. The non-transitory computer-readable medium of claim 17, wherein the method further comprises: maintaining a set of commands on the server for each of a plurality of users of a networked system, wherein the set of commands includes one or more commands customized for the user.

19. The non-transitory computer-readable medium of claim 17, wherein the method further comprises manipulating an operational aspect of a network resource in accordance with a default command when command information is determined to be absent from the one or more fields of the message.

20. The non-transitory computer-readable medium of claim 17, wherein the user is a non-registered user and the method further comprises:
upon receipt of the message, creating a registration message for transmission to the user; and
creating and subsequently maintaining a set of commands for the user.
